(19) United States
(12) Patent Application Publication
(10) Pub. No.: US 2013/0282901 A1
(43) Pub. Date: Oct. 24, 2013

(54) COMPUTER NETWORK NODE DISCOVERY

(71) Applicant: Sergei Mouravyov, La Jolla, CA (US)

(72) Inventor: Sergei Mouravyov, La Jolla, CA (US)

(21) Appl. No.: 13/991,468

(22) PCT Filed: Dec. 11, 2010
(86) PCT No.: PCT/US10/59978

§ 371 Date: Jun. 4, 2013

(51) Int. Cl. H04L 12/26

(52) U.S. Cl. CPC H04L 43/04
USPC 709/224

(57) ABSTRACT

A computer network node discovery process provides for collecting discovery data at least in part by having a computer query computer network nodes. The discovery data can include IPv6 addresses or MAC addresses or both. The discovery data can be expanded by converting IPv6 addresses to MAC addresses or converting MAC addresses to IPv6 addresses. The resulting expanded discovery data can be used to update a network inventor database at least in part by entering IPv6 or MAC addresses resulting from the conversions.

### BACKGROUND

Computer network node discovery is a process by which a computer, as directed by a software application, locates, identifies, and/characterizes network nodes. Discovery can be used to develop or update an inventory for network management purposes. More generally, a node can use discovery to determine network addresses of nodes with which it communicates so that it can communicate with the nodes to collect more detailed inventory data.

Various discovery techniques are available to discover nodes. For example, deep discovery techniques, e.g., those based on SNMP (Simple Network Management Protocol) querying, provide relatively complete information. However, frequent deep discovery can consume excessive network resources and resources on the node conducting the discovery. Also, not all network devices respond to SNMP discovery queries. ICMP and ICMPv6 (Internet Control Message Protocol version 4 and 6) ping and DNS (Domain Name System) queries provide for quick discovery of IPv4, IPv6 (Internet Protocol version 4 and 6) addresses and Domain Names. However, as a node's IPv4 address and Domain Name are typically programmable, it can be hard to determine, for example, whether a detected change is due to node reconfiguration, node movement or migration, or a data-entry error.

### BRIEF DESCRIPTION OF THE DRAWINGS

FIG. 1 is a schematic diagram of a network system in accordance with an embodiment.

FIG. 2 is a flow chart of a process in accordance with an embodiment used in the context of the network system of FIG. 1.

FIG. 3 is a schematic diagram of another network system in accordance with an embodiment.

FIG. 4 is a flow chart of a process used in the context of the network system of FIG. 3.

### DETAILED DESCRIPTION

Even when ICMP pings and DNS queries are combined with SNMP queries, the resulting inventory data can be incomplete. Also, in a network, devices may conform to different sets of communications protocols, and various security measures can affect which devices are accessible from which other devices and over what protocols. Especially in large networks, e.g., with thousands of nodes, other techniques may be useful in supplementing or replacing existing discovery techniques.

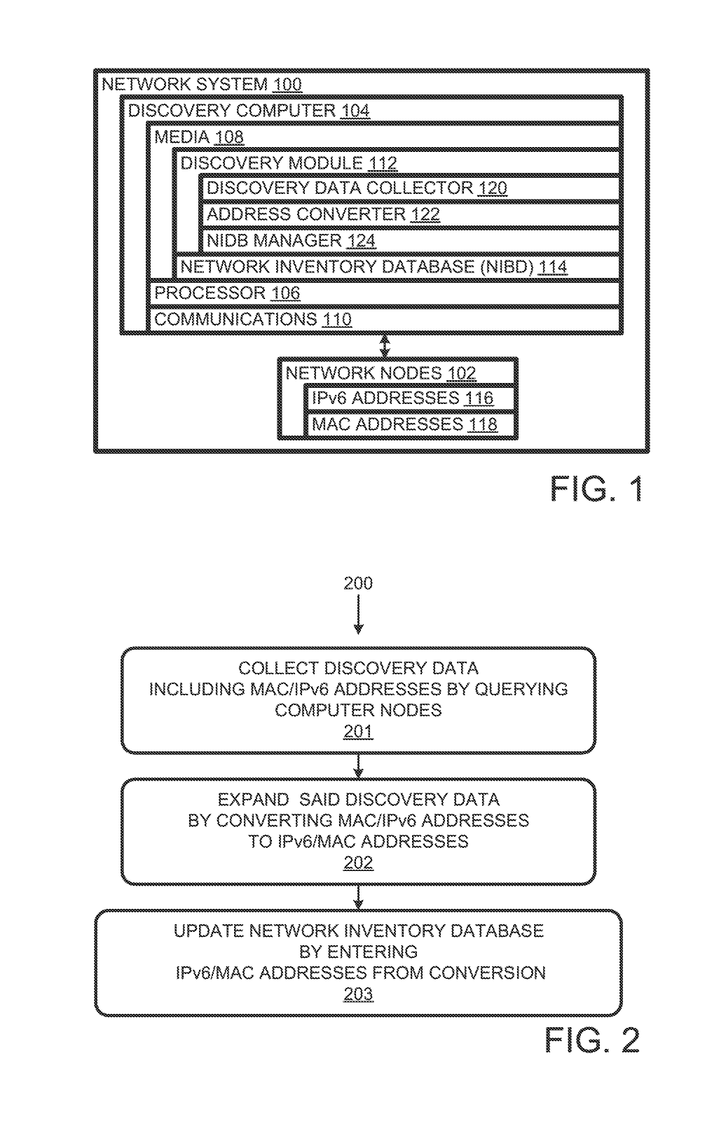

A network system 100, shown in FIG. 1, provides for discovery techniques that may supplement or replace existing network discovery techniques to provide for more complete and reliable inventory data. Network system 100 includes network nodes 102, which can include a discovery computer 104. Discovery computer 104 can be a management computer or simply one of many network nodes that maintains an inventory of its peers.

Discovery computer 104 includes computer-readable storage media 106, a processor 108, and communications devices 110. Media 108 is encoded with a discovery module 112 and a network inventory database 114. Discovery module 112 implements a process 220, flow charted in FIG. 2. At process segment 201, a discovery data collector 120 collects discovery data at least in part by querying computer network nodes 102. The collected discovery data includes IPv6 addresses 116 or MAC addresses 118. At process segment 202, an address converter 122 of discovery module 112 expands the discovery data at least in part by converting collected IPv6 addresses to MAC addresses or converting collected MAC addresses to IPv6 addresses. At process segment 203, an NIDB manager 124 of discovery module 112 updates NIDB 114 at least in part by entering the MAC or IPv6 addresses obtained by the conversion in process segment 202.

MAC addresses were designed to be unique addresses, typically permanent, for network connection devices. MAC addresses are used for network addresses at the data link layer, i.e., layer 2 of the 7-layer OSI (Open Systems Intercommunications) model for network communications, IPv6, like IPv4, is used for network addresses at the network layer, i.e., layer 3 of the OSI model. While IPv4 is prevalent, its stock of 32-bit addresses is being depleted; IPv6, which uses 128-bit addressees, is in place to deal with the rapidly expanding demand for IP addresses.

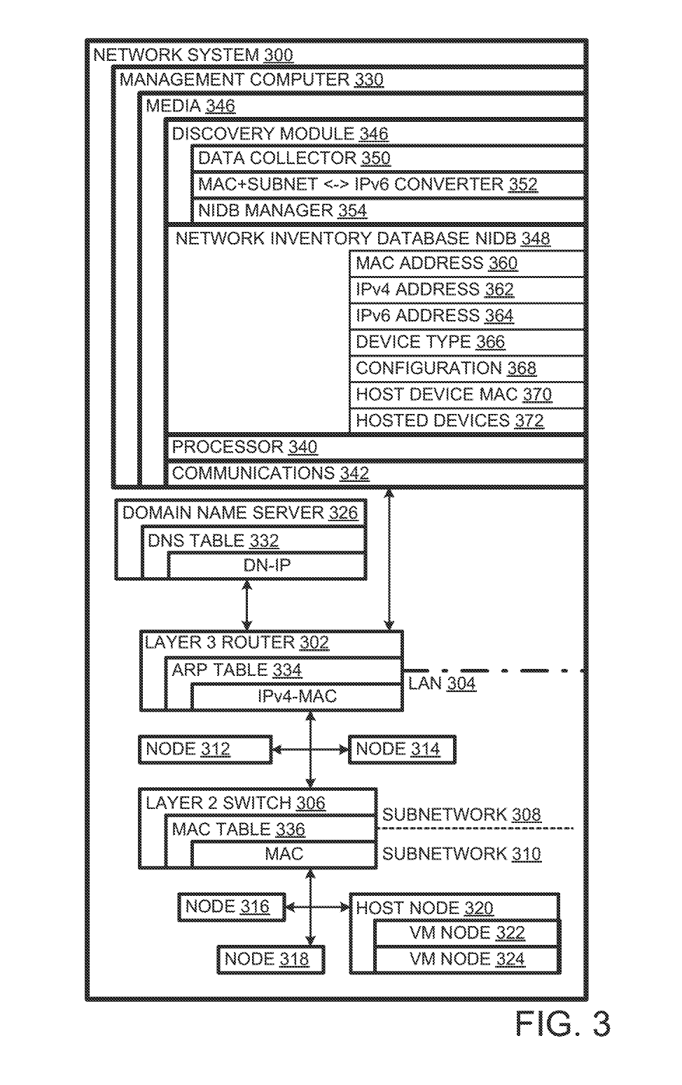

Even though their names differ by only a version number, IPv4 and IPv6 are very distinct protocols. For example, IPv6 differs from IPv4 not only in the number of available addresses, but in how the addresses are generated. While IPv4 addresses can be assigned almost arbitrarily, default IPv6 addresses are generated from MAC addresses and subnet identifiers in such a way that MAC addresses can be determined from IPv6 addresses. RFC 4291 (a Request for Comments published by the Internet Engineering Task force) defines how a host part of the IPv6 auto-configured address is formed from 48-bit IEEE802 MAC address. A discovery module, such as module 112, can take advantage of his convertibility to expand the information obtainable during discovery in situations in which discovery information is relatively sparse. This approach is also implemented by a network system 300, shown in FIG. 3.

Network system 300 includes thousands of nodes distributed among a multitude of local area networks (LANs) and subnetworks. Representative nodes, a. LAN, and subnetworks are shown in FIG. 3. More specifically, a router 302 defines a boundary for a LAN 304. Note that LAN 304 can be viewed as two completely independent LANs, an IPv4 LAN and an IPv6 LAN. This means that nodes running only IPv4 or IPv6 protocol stacks can be seen only on the respective IPv4 or IPv6 LAN. Nodes running both protocol stacks appear on both IPv4 and IPv6 LANs.

On a lower data-link layer (layer 2), LAN 304 is divided by a switch 306 into physical subnetworks 308 and 310. Subnetwork 308 includes nodes 312 and 314, while subnetwork 310 includes nodes 316, 318, and 320. Node 320 is a host computer hosting virtual machine nodes 322 and 324. Network system 300 includes a domain-name server 326 and management computer 330. In other embodiments, the number and types of nodes differ.

Domain name server 326 includes a DNS table 332 for converting between domain names and IP addresses. Both IPv4 and IPv6 are provided for where the information is available. Router 302 includes address resolution tables for IPv4 and IPv6 protocols associating respective IPv4 and IPv6 (layer 3) addresses with MAC (layer 2) addresses. Switch 306 includes a MAC table 334 that lists all MAC addresses that communicate through switch 306. Other network infrastructure devices, which are also network nodes, may have different information stored; e.g., multilayer switches may relate IP addresses, MAC addresses, and subset identities.

Management computer 330 includes a processor 340, communications (including input-output) devices 342, and computer-readable storage media (e.g., solid-state and disk-based memory) 344. Media 344 is encoded with a discovery module 346 and a network inventory database NIDB 348. Discovery module 346 includes a data collector 350, an address converter 352, and a NIDB manager 354. NIDB 348 is a relational database including tables, fields, and values for representing and associating MAC addresses 360, IPv4 addresses 362, IPv6 addresses 364, device type identifiers 366, configuration data (which can vary by device type), a host device MAC, if subject node has a host (e.g., a blade chassis hosting blades), and hosted devices 372, if the subject device hosts other devices (e.g., a computer hosting NICs (network interface cards). Alternatively, a non-relational database including fields and values can be used.

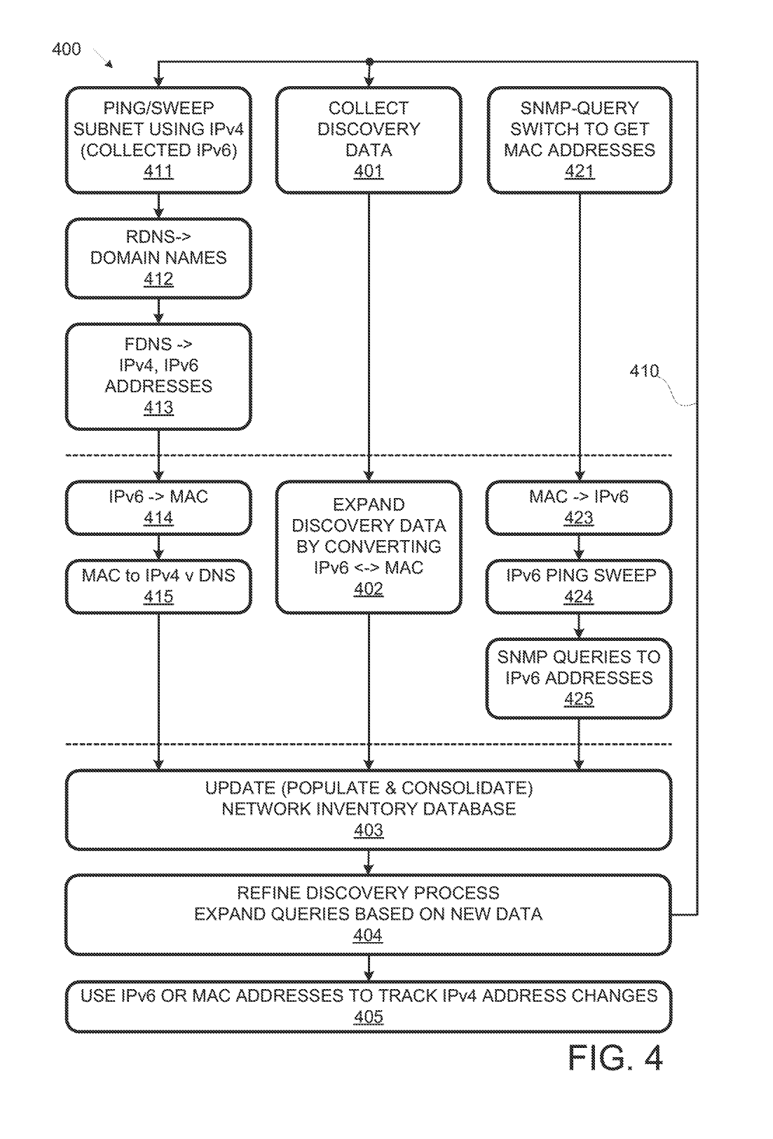

Discovery module 346 implements a process 400, flow-charted in FIG. 4. At process segment 401, data collector 350 queries network nodes and obtains MAC or IPv6 addresses from at least some of the devices responding to queries. At process segment 402, converter 352 converts between MAC and IPv6 addresses to obtain the complementary address. At process segment 403, NIDB manager 354 updates (populates, consolidates, revises, etc.) NIDB 348. At process segment 405, NIDB manager 354 provides the newly updated data to data collector 350 to begin a new iteration of process segments 401-403 using the newly updated data to refine the inventory data collection process. At process segment 405, NIDB manager 354 uses the IPv6 and/or MAC address to track IPv4 address changes.

in a variation, process 400 begins with a process segment 411 in which data collector 350 performs an ICMP IPv4 ping sweep over the IPv4 address range of LAN 304 by pinging each. IPv4 in the range. At process segment 412, IPv4 addresses are determined for the responding devices. At process segment 413, data collector 350 performs a reverse domain-name search (RDNS) using domain name server 326 to obtain domain names associated with the IPv4 addresses. At process segment 414, data collector 350 performs a forward domain name search (FDNB) using domain name server to obtain IPv6 addresses. At process segment 415, converter 452 converts the IPv6 addresses to MAC addresses. At this point, MAC addresses, IPv6 addresses, IPv4 addresses, and domain names are all associated. The associated data can be used to update NIDB 348 at process segment 403.

Process segment 404 provides for iterating a loop 410 including process segments 401-403 using expanded discovery data to refine discovery. In other words, each successor iteration uses some of the expanded discovery data for a predecessor iteration that was not part of the collected discovery data for that predecessor iteration. Since MAC addresses and IPv6 addresses are unlikely to change, they can be used to detect when an IPv4 address changes at process segment 405.

Note that blind (without some fore-knowledge of addresses actually used) IPv6 ping sweeps are impractical due to the number of addresses involved. In the variation beginning with process segment 411 described above, a more feasible IPv4 ping sweep is performed and the resulting data is converted to Obtain IPv6 data. In the following variation, data is obtained from switches to provide a limited number of IPv6 addresses to query so that, in effect, an IPv6 ping sweep can be performed.

This variation begins with a process segment 421 in which to data collector 450 queries a switch 306 to determine what MAC addresses have been associated with subnet 310 (or any other subnet) by packets being communicated to and through switch 306. In response to the queries, at process segment 422, data collector 350 obtains MAC addresses from switch 306. At process segment 423, address converter 352 converts the MAC addresses to IPv6 addresses by combining IPv6 subnet identifier(s) and IPv6 host part of the address obtained by transforming MAC address into host part of the IPv6 address. Note that subnet identifier(s) can be obtained by different means, i.e., from the router 302, any other node on LAN 304 or configured by end user. At process segment 424, data collector 350 performs an IPv6 ping sweep using the IPv6 addresses obtained at process segment 423 to confirm IPv6 addresses. The collected data can be used to update NIDB 348 at process segment 404, and the relatively permanent IPv6 addresses can be used to detect and track changes in IPv4 addresses at process segment 405.

Herein, a “system” is a set of interacting non-transitory tangible elements, wherein the elements can be, by way of example and not of limitation, mechanical components, electrical elements, atoms, physical encodings of instructions, and process segments. Herein, “process” refers to a sequence of actions resulting in or involving a physical transformation. Herein, “discovery” refers to a process by which a network node obtains information regarding the identities, types, and configurations of other network nodes.

“Storage medium” and “storage media” refer to a system including non-transitory tangible material in or on which information is or can be encoded so as to be readable, e.g., by a computer or a human. “Computer-readable” refers to storage media in which information is encoded in computer-readable form. “Display medium” and “display media” refer to storage media in which information is encoded in human readable form.

Herein (unless preceded by the word “virtual”) “machine”, “device”, and “computer” refer to hardware or a combination of hardware and software, A “virtual” machine, device or computer is a software analog or representation of a machine, device, or server, respectively, and not a “real” machine, device, or computer, A “server” is a real (hardware or combination of hardware and software) or virtual computer that provides services to computers. Herein, unless otherwise apparent from context, a functionally defined component (e.g., collector, converter, or manager) of a computer is a combination of hardware and software executing on that hardware to provide the defined functionality.

Herein, a “computer” is a machine having co-located or distributed components including computer-readable storage media, a processor, and one or more communications devices. The media stores or is configured to store code representing data including computer-executable instructions. The processor, which can include one or more central-processing units (CPUs), reads and manipulates data in accordance with the instructions. “Communication(s) device(s)” refers to (typically computer-hosted) devices used to transmit and/or receive data. Herein, a “computer network” is a network of communicatively coupled real and, in some cases, virtual nodes, wherein the nodes can be, by way of example and not of limitation, servers, network infrastructure devices, and peripherals. Herein, “node” encompasses real and virtual devices.

In this specification, related art is discussed for expository purposes. Related art labeled “prior art”, if any, is admitted prior art. Related art not labeled “prior art” is not admitted prior art. In the claims, “said” qualifies elements for which there is explicit antecedent basis in the claims; “the” refers to elements for which there is implicit antecedent basis in the claims; for example, the phrases “the center of said circle” indicates that the claims provide is explicit antecedent basis for “circle”, which also provides as implicit antecedent basis for “center” since every circle contains exactly one center. Throughout, “or” represents an inclusive or, which is synonymous with “and/or”. The illustrated and other described embodiments, as well as modifications thereto and variations thereupon are within the scope of the following claims.

What is claimed is:

1. A computer network node discovery process comprising:
collecting collected discovery data at least in part by having a computer query computer network nodes, said discovery data including IPv6 addresses or MAC addresses;
expanding said collected discovery data to obtain expanded discovery data at least in part by having said computer convert IPv6 addresses to MAC addresses or convert MAC addresses to IPv6 addresses; and
updating a network inventory database at least in part by entering therein at least some of IPv6 or MAC addresses obtained by the converting.

2. A process as recited in claim 1 further comprising tracking changes in IPv4 addresses using said MAC and/or IPv6 addresses.

3. A process as recited in claim 1 wherein:
said collecting includes
performing an ICMP IPv4 ping sweep so as to obtain IPv4 addresses,
performing a reverse domain name service look up to obtain domain names using said IPv4 addresses, and
performing a forward domain name service lookup to obtain IPv6 addresses using said domain names; and
said converting involving converting said DNS addresses to MAC addresses.

4. A process as recited in claim 1 wherein:
said querying includes performing an SNMP query on a switch to obtain MAC addresses; and
said converting involves converting MAC addresses into IPv6 addresses.

5. A process as recited in claim 1 further comprising refining discovery by iterating said collecting, expanding, and updating using said expanded discovery data.

6. A system comprising a computer network node discovery module including:
a data collector configured to collect IPv6 or MAC addresses at least in part by querying network nodes to discover addresses;
an address converter configured to convert between IPv6 addresses and MAC addresses to yield expanded discovery data; and
a network inventory database manager configured to update a network inventory database using said expanded discovery data.

7. A system as recited in claim 6 wherein said data collector is configured to collect MAC addresses via an SNMP query to a OSI layer 2 switch.

8. A system as recited in claim 6 wherein said data collector is configured to collect IPv6 addresses using:
a reverse domain lookup to convert IPv4 addresses to domain names; and
forward domain name lookups to convert domain names to IPv6 addresses.

9. A system as recited in claim 6 wherein said address converter is configured to generate IPv6 addresses from MAC addresses and subnet identifiers.

10. A system as recited in claim 6 wherein said collector is configured to perform a ping sweep to obtain IPv4 addresses from both real and virtual devices.

11. A system comprising computer-readable storage media encoded with code configured to, when executed by a processor:
collect collected discovery data at least in part by having a computer query computer network nodes, said discovery data including IPv6 addresses or MAC addresses;
expand said collected discovery data to obtain expanded discovery data at least in part by having said computer convert IPv6 addresses to MAC addresses or convert MAC addresses to IPv6 addresses; and
update a network inventory database at least in part by entering therein at least some of IPv6 or MAC addresses obtained by the converting.

12. A system as recited in claim 11 wherein said code is further configured to iteratively collect, expand, and update with a successor iteration using some of the expanded discovery data for a predecessor iteration that was not part of the collected discovery data for that predecessor iteration.

13. A system as recited in claim 11 wherein said code is further configured to use data obtained by the converting to track IPv4 addresses changes.

14. A system as recited in claim 11 wherein said collecting involves an SNAP query of a switch and said expanding involves an IPv6 ping sweep.

15. A system as recited in claim 11 wherein said collecting involves an IPv4 ping sweep and said expanding involves converting IPv6 addresses to MAC addresses.
